(19) United States
(12) Patent Application Publication
(10) Pub. No.: US 2015/0018993 A1
(43) Pub. Date: Jan. 15, 2015

(54) SYSTEM AND METHOD FOR AUDIO PROCESSING USING ARBITRARY TRIGGERS

(71) Applicant: Mehul A. Trivedi, San Francisco, CA (US)

(72) Inventor: Mehul A. Trivedi, San Francisco, CA (US)

(73) Assignee: AliphCom, San Francisco, CA (US)

(21) Appl. No.: 14/328,665

(22) Filed: Jul. 10, 2014

Related U.S. Application Data
(60) Provisional application No. 61/844,488, filed on Jul. 10, 2013.

(51) Int. Cl. G11B 20/10; G11B 27/11

(52) U.S. Cl. CPC G11B 20/10; G11B 27/11
USPC 700/94

(57) ABSTRACT

The present disclosure relates to audio processing for playback, and more particularly to processing audio files to provide a smooth transition between successive audio tracks during playback. According to some examples, a flow includes determining, with a computing device, a first audio characteristic of a first audio track and determining, with the computing device, a second audio characteristic of a second audio track. The flow can further include receiving, at the computing device, data representing a user-generated trigger. The flow further can determine a transition parameter, responsive to the user-generated trigger, for the first audio track and the second audio track based on one or more of the first audio characteristic and the second audio characteristic. Also, the flow can cause presentation of a transition from the first audio track to the second audio track.

### CROSS-REFERENCE TO RELATED APPLICATIONS

This application claims the benefit of U.S. Provisional Patent Application No. 61/844,488, filed with the U.S. Patent and Trademark Office on Jul. 10, 2013, and entitled, “System and Method for Audio Processing Using Arbitrary Triggers,” which is incorporated herein by reference.

### FIELD

The present disclosure relates to audio processing for playback, and more particularly to processing audio files to provide a smooth transition between audio tracks during playback.

### BACKGROUND

As a result of advances in audio compression, availability of broadband Internet access both at home and on mobile devices, and the growing popularity of cloud-based music streaming services, users have access to an increasingly large library of music content. Additionally, computing devices used to play this audio content, such as smartphones, tablets, digital music players, laptops, desktops, smart televisions, home theater systems, and other computing devices, have become powerful enough to perform sophisticated signal processing.

It can be desirable to present audio tracks as seamless stream with smooth transitions between tracks and no break in playback. Automatic audio mixing and playback systems which provide smooth transitions between songs are known. For instance, an automatic disc jockey (“DJ”) can be implemented as a software junction in a consumer hardware platform that has “knowledge” of music. The automatic DJ can choose and mix songs from a given database. An automatic DJ is not a tool that is used by human users to perform audio mixing. Rather, the automatic DJ is a replacement for the human user and operates with minimal intervention.

A drawback of the known automatic mixing methods is the requirement for predetermined mix points between tracks. Once determined, a conventional transition happens usually only after reaching a predetermined mix in the current track. If a new song is desired prior to that point, the ability to listen to a continuous stream is lost.

### SUMMARY

One exemplary aspect of the present disclosure is directed to a computer-implemented method. For example, a flow includes determining, with a computing device, a first audio characteristic of a first audio track and determining, with the computing device, a second audio characteristic of a second audio track. The flow can further include receiving, at the computing device, data representing a user-generated trigger. The flow further can determine a transition parameter, responsive to the user-generated trigger, for the first audio track and the second audio track based on one or more of the first audio characteristic and the second audio characteristic. Also, the flow can cause presentation of a transition from the first audio track to the second audio track.

In particular implementations, the first audio characteristic and the second audio characteristic can be a tempo, beat phrase, key, time signature, or any other audio characteristic. In some embodiments, an audio characteristic can be characteristic describing an attribute of music or a song (i.e., audio characteristic can be a music characteristic). A transition parameter can include one or more of a mix point, a reverb parameter, a fade out time, a fade in time, a playback rate, or any other transition parameter. The user-generated trigger can include user interaction with a user interface element in software or hardware, gesture detection, or use of sensors to detect changes in the environment.

Another exemplary aspect of the present disclosure is directed to a computer-implemented method. The method includes calculating audio (e.g., musical) characteristics or elements such as tempo, beat phase, meter and phrase boundaries on the current and upcoming content. In situations where the audio data for a piece of content is not available in its entirety (e.g., when streaming a song from a remote source), the method can include monitoring the availability of new data and reprocessing as necessary. The method can further include matching the content to one or more remote media content libraries and using metadata information of the two pieces to determine the most appropriate midpoint and mixing parameters for any given trigger time. The method can further include monitoring for trigger events, and on execution applying the specified mixing parameters at the calculated midpoint.

Yet another exemplary aspect of the present disclosure is directed to a computer-implemented method. The method includes identifying and matching content with media content stored on one or more remote computing devices to determine one or more identifiers for the media object. The identifiers can be used calculate maximally effective timing and mixing instructions between any two pieces of audio content.

The present disclosure is also directed to systems, apparatus, non-transitory computer-readable media, devices, and user interfaces for providing smooth transitions across audio tracks.

These and other features are understood with reference to the following description and appended claims. The accompanying drawings, which are incorporated in and constitute a part of this specification, illustrate and describe various embodiments of the invention and, together with the description, serve to explain the principles of the embodiments.

Therefore, it is desirable to provide a system that allows user interaction to trigger a transition from the current song to the next, coupled with “knowledge” of music characteristics to determine timing and mixing parameters. A system that would allow for mixing at arbitrary points is useful.

### BRIEF DESCRIPTION OF THE DRAWINGS

A full and enabling disclosure of the present invention, including the best mode thereof, directed to one of ordinary skill in the art, is set forth in the specification, which makes references to the appended figures, which:

FIG. 1 is a functional block diagram depicting a computing device configured to autonomously transition audio tracks, according to some embodiments;

FIG. 2 depicts an example of a flow diagram for transitioning between two audio tracks, according to some embodiments;

FIG. 3 depicts an example of a computing system, according to one or more embodiments;

FIGS. 4 and 5 depict respectively a track parameter analyzer and an autonomous mixer to facilitate transitioning audio tracks, according to some embodiments;

FIG. 6 depicts implementation of various sensor-based trigger data for initiating transition of audio tracks, according to some embodiments;

FIG. 7 depicts another example of a computing system, according to one or more embodiments; and

FIG. 8 illustrates an exemplary computing platform configured to provide autonomous audio transitions in accordance with various embodiments.

### DETAILED DESCRIPTION

Reference now will be made in detail to embodiments of the invention, one or more examples of which are described in association with the drawings. The examples are provided by way of explanation of the various embodiments, and do not limit the scope of the one or more embodiments. It is apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the various embodiments cover such modifications and variations as come within the scope of the appended claims and their equivalents.

Generally, the present disclosure is directed to systems and methods for providing transitions between audio tracks in response to a user gesture, or the like. More particularly, aspects of the present disclosure are directed to providing a system for seamlessly (or near seamlessly) transitioning audio playback autonomously from one piece of content to the next, triggered by user interaction at an arbitrary point in time. Using a method for identifying relevant musical characteristics or features in an audio track (including but not limited to the tempo, beat phase, key, and time signature), optionally combined with additional track metadata (whether contained in the file, or by a method for identifying the content and matching it to a library with that metadata), a device can facilitate autonomous “mixing” of songs by calculating, based on user interaction, a maximally effective time and style/profile for the transition, in addition to applying the necessary processing for both tracks. This provides a user with the experience and creative freedom of a professional DJ autonomously.

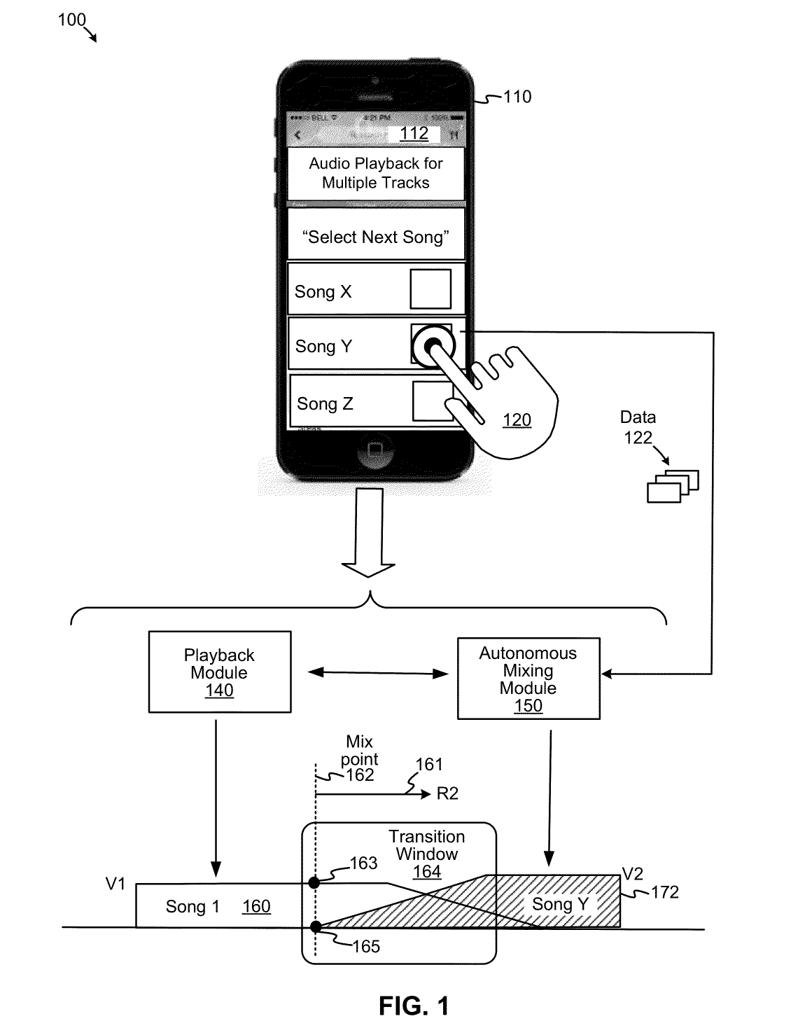

FIG. 1 is a functional block diagram depicting a computing device configured to autonomously transition audio tracks, according to some embodiments. Diagram 100 depicts a playback module 140 configured to cause presentation aurally to a user a first audio track, such as a song (“1”) 160, and diagram 100 further depicts an autonomous mixing module 150 configured to transition autonomously the presentation of audio from song 160 to song (“Y”) 172.

As shown, playback module 140 and/or autonomous mixing module 150 can be implemented in a computing device, such as a mobile computing device 110, having a user interface 112. As an example, consider that during playback or presentation of song 160 a user desires to select another audio track or song to be presented. User interface 112 is shown to present selections for song X, song Y, and song Z. Further, consider that user 120 selects song Y, whereby a user interface-generated signal representing the selection is transmitted as data 122 to autonomous mixing module 150. Data 122 can include data representing a song identifier (“ID”) for song 172, as well as other data to facilitate an automatic transition via autonomous mixing.

Autonomous mixing module 150 can be configured to determine one or more transition parameters for facilitating transition during a transition window 164 as audio transitions from song 160 to song 172. For example, autonomous mixing module 150 can be configured to identify audio characteristic 163 of song 160 and identify audio characteristic 165 of song 172, whereby a mix point 162 can be determined as a transition parameter. In some cases, autonomous mixing module 150 aligns audio characteristic 165 of song 172 to audio characteristic 163 of song 160 to form mix point 162. Other transition-related parameters can be determined and/or implemented, such as the rate at which song 160 fades from a volume level V1 or the rate at which song 172 fades to a volume level V2. Also, autonomous mixing module 150 can be configured to determine a rate (“R2”) 161 to which song 172 is transitioned based on, for example, determinations of the tempos of songs 160 and 172.

In view of the foregoing, the structures and/or functionalities of autonomous mixing module 150 (and/or other elements described herein) can facilitate seamless (or substantially seamless) transitioning from one audio track to another audio track autonomously. In accordance with various embodiments, an autonomous mixing module 150 (and/or other components described herein) can determine in situ transition parameters to facilitate mixing of song 172 at any point during playback of song 160. In some examples, transition parameters can be determined between a currently playing song and another song after, for instance, the selection of the other song for playback. According to some implementations, mixing points for songs 172 and 160 need not be determined prior to selection of one of the two songs. As such, various features described herein can facilitate song transitions via mixing whereby a user need not manually determine, set, or use a predetermined mix point. Thus, a midpoint can be implemented at one or more arbitrary points in time in accordance with various embodiments.

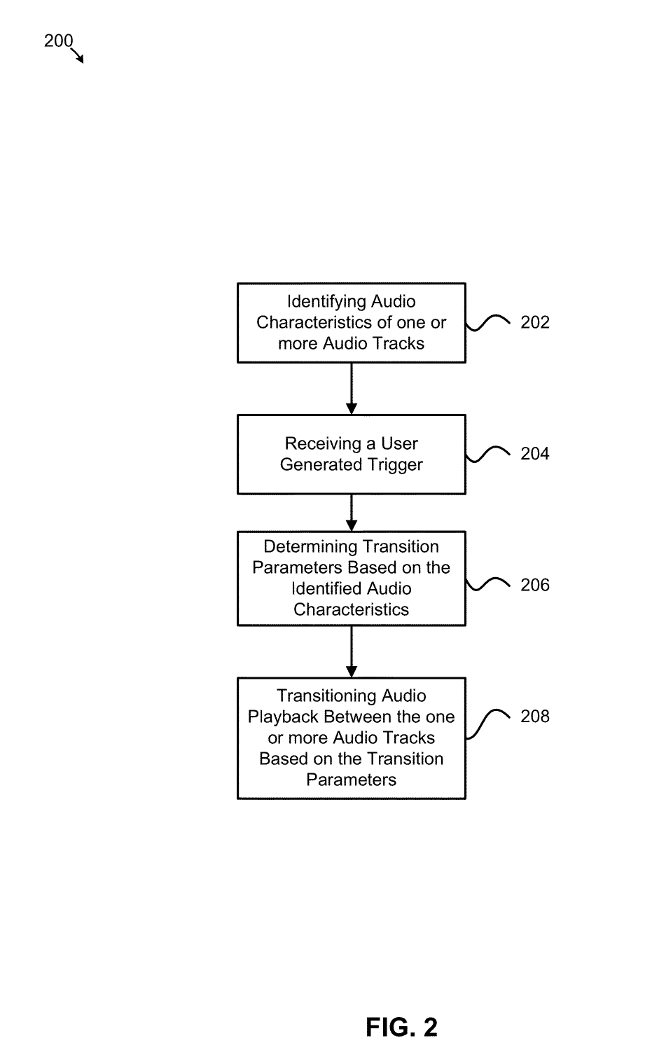

FIG. 2 depicts an example of a flow diagram 200 for transitioning between two audio tracks, according to some embodiments. Flow 200 can be implemented by any one or more suitable computing devices, such as a smartphone, tablet, digital music player, laptop, desktop, smart television, home theater system, or other computing device, including servers (e.g., web servers). Note that portions of flow 200 can be rearranged, omitted, adapted, modified, or expanded in various ways, according to various implementations.

At 202, flow 200 includes identifying one or more relevant audio characteristics of one or more audio tracks. The one or more identified audio characteristics can relate to, or include, tempo, beat phase, key, time signature, and/or other audio characteristics. The audio characteristics can be identified using a number of different methods, or several in conjunction for additional accuracy. For instance, digital file metadata (such as an ID3 tag of an MP3 audio file, or other similar data arrangements that describe characteristics of audio or music or imagery), manual user tagging, or calculation using the raw audio data of the content (such as onset and beat detection from a files waveform) can be used to identify audio characteristics. Further, an audio characteristic can be calculated or otherwise derived, according to some embodiments. According to some examples, an audio characteristic can include a musical characteristic, or can be described, at least in one case, as a musical characteristic.

Identifying audio characteristics can also include identifying metadata associated with the audio tracks. Metadata associated with an audio track can be derived from a locally-stored audio track or a remotely-stored audio track. In some examples, the metadata can be extracted from remote media content libraries or music streaming services (e.g., Spotify™, Rdio™, iTunes™, etc.). For example, one or more audio tracks identified for presentation at a computing device can refer to one or more reference tracks that might be stored remotely. In some cases, metadata for the one or more audio tracks at a computing device can be matched to one or more reference tracks contained in remote media content libraries. The content can be identified against one or more reference databases, so that device content can be identified against other device content, as well as content associated with an external system (such as a digital content delivery network archive, a music streaming service, etc.).

At 204, a user-generated trigger is received. The user-generated trigger can be embodied in data associated with a signal indicative of a user desiring to initiate transition to another audio track (e.g. skipping to the next song in a playlist). The user-generated trigger can be implemented using any suitable technique. For instance, a user can interact with a user interface element in software or hardware (e.g. a physical or on-screen button) to trigger the transition. The user-generated trigger can also be based on gesture detection (e.g. shaking a device, swiping across a screen, etc.,), whereby gesture can be detected (e.g., by a gesture detector) to initiate a transition. The user-generated trigger can also be based on signals received from sensors (e.g., audio noise sensors, accelerometers, motion sensors, etc.) for detecting changes in the environment (e.g. a drop or rise in ambient noise or movement). Movement can be detected by way of a motion sensor.

At 206, flow 200 can determine one or more transition parameters based on audio characteristics and/or metadata identified for the audio tracks, in response to the user-generated triggering event. This can be performed either at the playback device itself (e.g., audio generation device logic or circuitry), or from an external system with which the playback device communicates (e.g. a web server). In some embodiments, a transition parameter can include a mixing point. For example, a mixing point can be determined autonomously as a point at which the playback of music transitions from a first audio track to a second audio track. According to aspects of the present disclosure, the mixing point can be determined to fall at, near, or on the beat of the first audio track after receiving the user-generated triggering event.

One or more transition parameters can further include, but are not limited to, volume changes (e.g., data representing fade-in and fade-out parameters), playback control (e.g., data representing a start operation, a stop operation, and the like), application of processing effects (e.g. reverb, delay, high/low pass filters), and other parameters). In some embodiments, transition parameters can be specified using a scheduling system in association with operation of the playback device, which denotes a change as an event structure with timing information (e.g., a time of start, duration, etc.) and relevant parameters (e.g., a rate of change, a start value, an end value, etc.).

At 208, flow 200 can cause transitioning of audio playback between the audio tracks based on one or more transition parameters. In particular, flow 200 can include reading or acquiring audio data for playback, processing that data in accordance with the transition parameters (e.g., adding a mix point at one or more arbitrary points in time, fade in/fade out, and other processing effects), and rendering the processed signal for playback on an output device (e.g. speakers, headphones, etc.). This can be performed on the device on which the content is being controlled and processed, or on a separate output device.

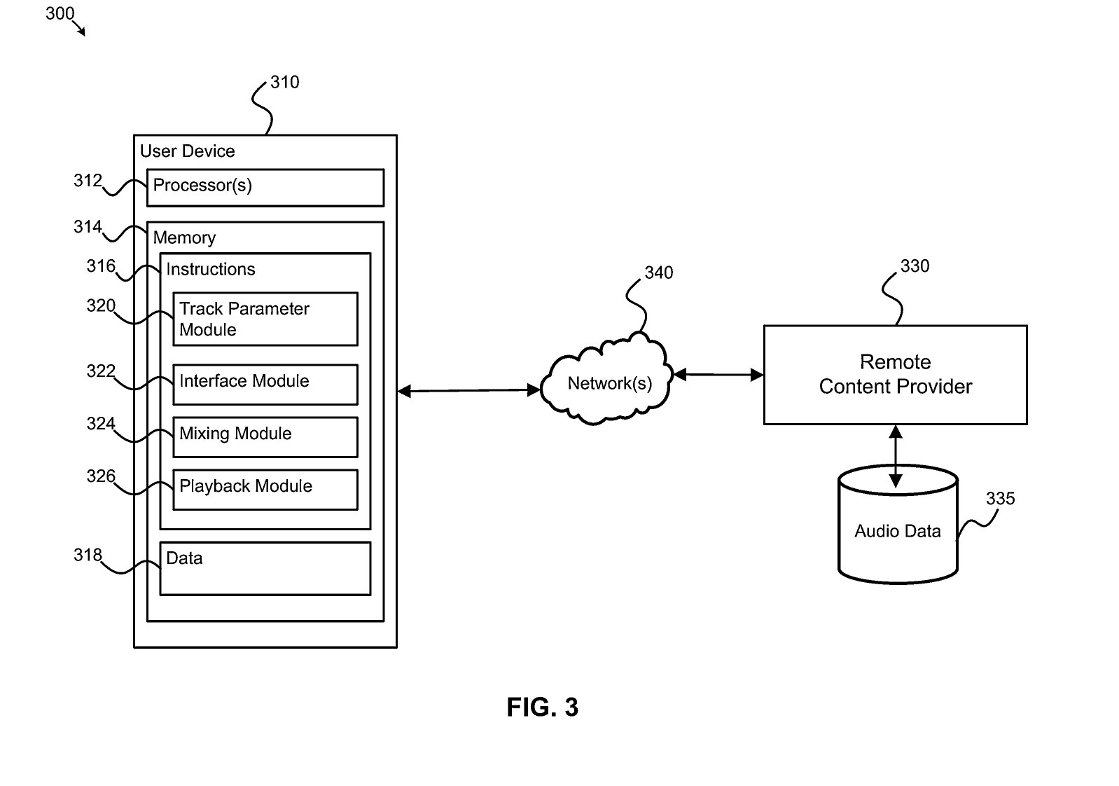

FIG. 3 depicts an example of a computing system, according to one or more embodiments. System 300 includes a computing device 310, which can be one or more of any device or machine capable of processing media, such as audio and/or video content. For instance, a computing device can include a smartphone, tablet, digital music player, laptop, desktop, smart television, home theater system, and other computing device.

Computing device 310 can have a processor(s) 312 and a memory 314. Computing device 310 can also include a network interface used to communicate with remote computing devices over a network 340. A network interface can include any suitable component for interfacing with one more networks, including for example, transmitters, receivers, ports, controllers, antennas, or other suitable components. In particular implementations, computing device 310 can be in communication with a remote content server 330, such as a web server, via network 340. Remote content server 330 can be coupled to, or in communication with, an audio database 335. Database 335 can include media for serving to remote devices and associated metadata. In particular implementation, a user device implemented as computing device 310 can access content (e.g., streamed audio content) from remote content server 330.

Processor(s) 312 can be any suitable processing device, such as a microprocessor. Memory 314 can include any suitable computer-readable medium or media, including, but not limited to, non-transitory computer-readable media, RAM, ROM, hard drives, flash drives, magnetic or optical media, or other memory devices. Memory 314 can store information accessible by processor(s) 312, including instructions 316 that can be executed by processor(s) 312. Memory 314 can also include data 318 that can be retrieved, manipulated, created, or stored by processor(s) 312. In some examples, data 318 can include metadata, transitional parameter data, audio characteristic data, and the like). Instructions 316 can be any set of instructions that, when executed by the processor(s) 312, cause any of processor(s) 312 to provide desired functionality. For instance, instructions 316 can be executed by processor(s) 312 to implement a track parameter module 320, an interface module 322, a mixing module 324, and a playback module 326.

Track parameter module 320 can be configured to identify and/or calculate the relevant audio or musical characteristics of one or more audio tracks (e.g., determining tempo or beats-per-minute for one or more songs) and to identify relevant metadata associated with the audio tracks, for instance, by requesting information stored in database 335 coupled to remote content server 330 (e.g., fetching song metadata). Interface module 322 can be configured to receive data representing a signal for causing a triggering of a transition between audio track based on a user interaction (e.g., from a user interacting with an interface or from other inputs and/or signals, such as a gesture recognition signals, environment signals, motion signals, or other signals).

Mixing module 324 is configured to determine one or more transition parameters in response to a user-generated trigger. For instance, mixing module 324 can use the information determined by track parameter module 320 to determine the appropriate parameters (e.g. the mixing point) and processing for the transition. Mixing module 324 can be implemented on computing device 310. Alternatively and/or in addition, mixing module 324 can be implemented at remote content server 330.

In some embodiments, a quantity representative of a tempo map can be calculated for the audio tracks to determine potential mixing points throughout the one or more audio tracks. On commencement of a user-generated trigger, a quantity representative of a tempo map at an event point of an audio track can be used in conjunction with the timing of the event relative to a start time of an audio playback to determine appropriate parameters for the transition.

Playback module 326 is configured to control playback of the audio tracks according to the transition parameters determined by mixing module 324. Playback module 326 can generate the processed signal for playback on an output device.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

Computing device 310 can include or can be coupled to one or more input/output devices. Input devices may correspond to one or more peripheral devices configured to allow a user to interact with the computing device. One exemplary input device can be a touch interface (e.g. a touch screen or touchpad) that allows a user to provide a user-generated trigger. The output devices can correspond to devices used to provide information to a user. One exemplary output device includes a suitable audio output (e.g. speakers, headphones, radio transmitter) for playing audio to the user. The computing device 310 can include or be coupled to other input/output devices, such as a keyboard, microphone, mouse, printer, and/or other suitable input/output devices.

The network 340 can be can be any type of communications network, such as a local area network (e.g. intranet), wide area network (e.g. Internet), or some combination thereof. The network can also include direct connections between any of the computing devices. In general, communication between the computing devices can be carried via a network interface using any type of wired and/or wireless connection, using a variety of communication protocols, encodings or formats, and/or protection schemes.

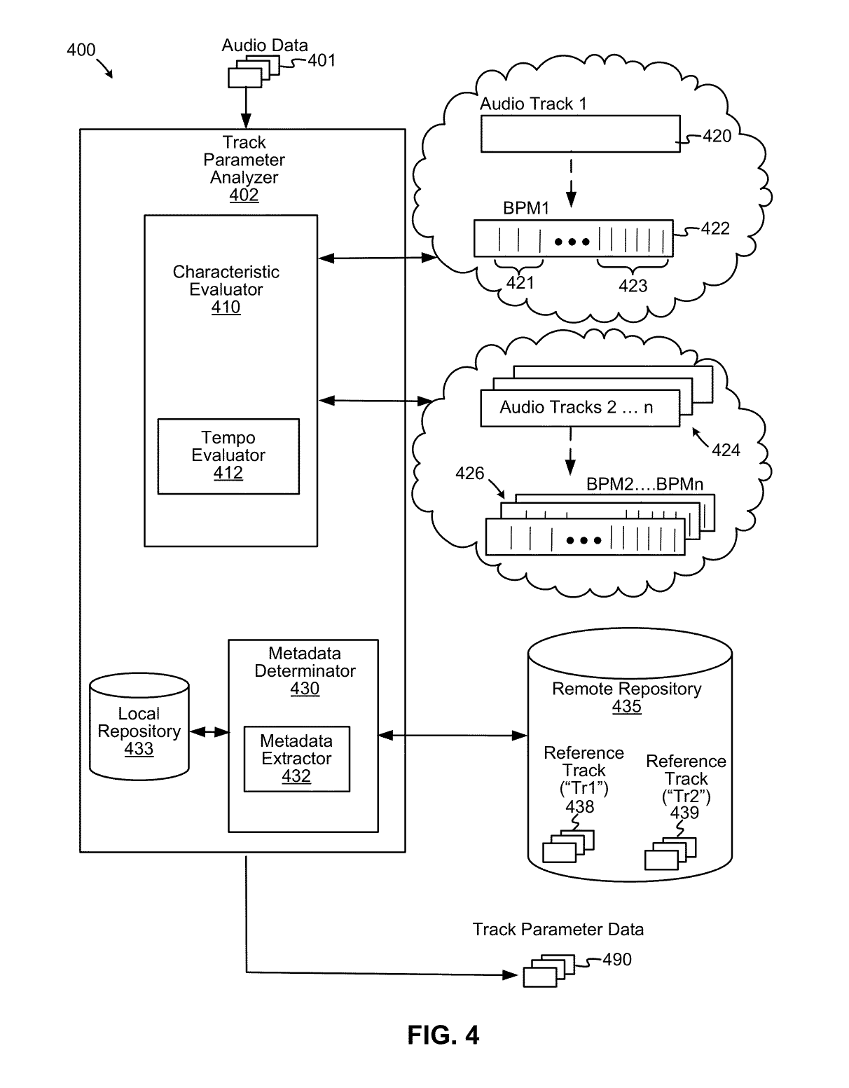

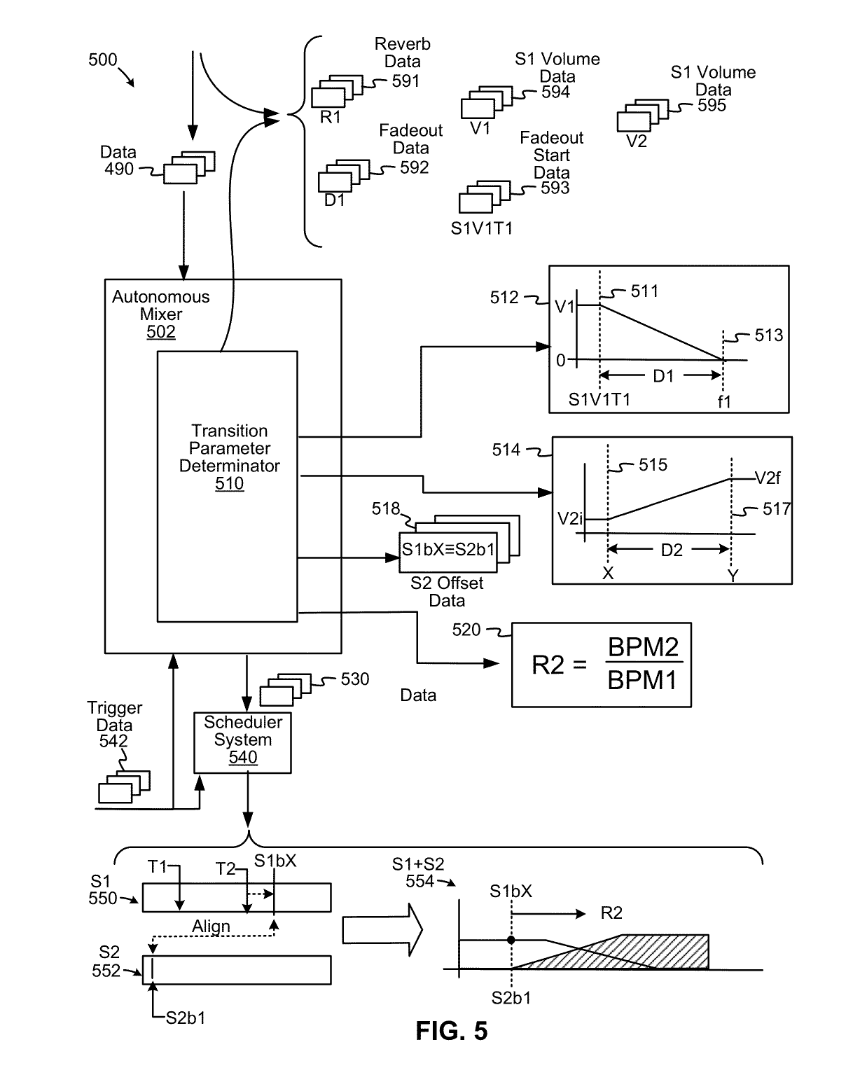

FIGS. 4 and 5 depict respectively a track parameter analyzer and an autonomous mixer to facilitate transitioning audio tracks, according to some embodiments. Diagram 400 depicts a track parameter analyzer 402 including a characteristic evaluator 410 and a metadata determinator 430, and configured to determine track parameter data 490. Characteristic evaluator 410 is configured to determine one or more characteristics of audio data 401 for one or more audio tracks.

According to one embodiment, a tempo evaluator 412 of characteristic evaluator 410 is configured to determine the tempo for an audio track (“1”) 420 and tempos for audio tracks (“2 . . . n”) 424. For example, tempo evaluator 412 is configured to determine beats-per-minute (“BPM1”) 422 for audio track 420, with which BPM1 422 can be used to determine the timing of a beat relative to a start time of audio track 420. For example, tempo evaluator 412 can determine beats occurring at times S1B1, S1B2, . . . , S1Bn etc. In some cases, portions 421 and 423 can be determined to have different beat rates as a song slows or speeds up from one portion to another. Note that audio track 420 can be song to which a user is currently listening on a device at a playback time, T1. Further, tempo evaluator 412 can be configured to determine one or more beats-per-minute (“BPM2 . . . BPMn”) 426 for one of audio tracks 424, with which BPM2 426 can be used to determine the timing of a beat relative to a start time of audio track 420. For example, tempo evaluator 412 can determine beats occurring at times S2B1, S2B2, . . . , S1Bm etc. In some cases, one or more portions of BPM 426 can be determined to have different beat rates as a song slows or speeds up from one portion to another. In some cases, data representing BPM can be transition parameters derived from calculations based on the detection analysis of audio tracks 420 and 424.

Metadata determinator 430 is configured to determine metadata associated with one or more audio tracts 420 and 424. In some examples, metadata determinator 430 can identify audio track 420 (e.g., as song 1) as a reference track, Tr1. As shown, reference track, Tr1, can be disposed as data representing reference track 438 in remote repository 435. Also, metadata determinator 430 can identify one of audio tracks 424 (e.g., as song 2) as a reference track, Tr2. As shown, reference track, Tr2, can be disposed as data representing reference track 439 in remote repository 435. Further, metadata determinator 430 includes a metadata extractor 432 is configured to extract metadata information from reference tracks 438 and 439, or from metadata information associated with audio tracks stored in local repository 433. Track parameter analyzer 402, including characteristic evaluator 410 and metadata determinator 430, is configured to transmit track parameter data 490 to an autonomous mixer.

FIG. 5 depicts an autonomous mixer configured to transition audio playback from one audio track to a next audio track, according some embodiments. Diagram 500 depicts an autonomous mixer 502 including a transition parameter determinator 510, and a scheduler system 540. According to one embodiment, transition parameter determinator 510 is configured to generate one or more sets of data 591 to 595 based on data 490 from track parameter analyzer 402 of FIG. 4, that represent, for example, transition parameters. For example, transition parameter determiner 510 can determine reverb data (“R1”) 591 for application to, for instance, song (“S1”) 550, fade-out duration data (“D1”) 592, song 1 volume (“V1”) data 594, fade-out start data (“S1V1T1”) 593, song 2 volume (“V2”) data 595, among other sets of data. Note that, according to some embodiments, one or more sets of data 591 to 595 can be derived or received from data 490.

Transition parameter determinator 510 is configured to determine an optimal mix point, S1Bx, where S1Bx>T2, which is a point in playback time in which trigger data 542 is received, whereby trigger data 542 are indicative of a user-generated trigger to transition audio tracks. Transition parameter determinator 510 is configured to determine the mix point aligning beat Bx for song 1 (i.e., S1Bx) and beat 1 for song 2 (i.e., S2b1), whereby the mix point data 518 can be also indicate an offset for song 2 to indicate at point in time at which to initiate playback of song (“S2”) 552.

Further, transition parameter determinator 510 is configured to use metadata of Tr1 and Tr2 to determine initial volume (“V2i”) data 595 for song 2, reverb parameter (“R1”) data 591 for song 1, fade-out time (“D1”) 592, and start time of fade-out (“S1V1T1”). As shown in inset 512, transition parameter determinator 510 is configured to determine a rate at which a first song fades out from volume level “V1” to volume level “0” after duration “D1” (from data 592). Duration D1 begins at a point in time (“S1V1T1”) 511 and decreases to another point in time (“f1”) 513. As shown in inset 514, transition parameter determinator 510 is configured to determine a rate at which a second song fades in from volume level “V2i” to volume level “V2f” after duration “D2” (from data 595, etc.). Duration D2 begins at a point in time (“X”) 515 and increases to another point in time (“Y”) 517. Also, transition parameter determinator 510 is configured to determine a rate, R2, of playback for a second song, S2, as shown in inset 520. In particular, transition parameter determinator 510 is configured to calculate playback rate R2 as BPM2/BPM1 for S2, whereby BPM2=R2*BPM1. Transition parameter determinator 510 can also set a processing parameter, which is optional, such a reverb parameters R1 for S1.

Data 530 from transition parameter determinator 510 is transmitted to scheduler system 540, which is configured to schedule and/or implement the above-described data (e.g., transition parameters, audio characteristics, etc.) to cause presentation of a transition an audio from song 550 to song 552. As an example, consider that song (“S1”) is currently being presented at a point in time, T1. At T2, a trigger event is detected, whereby autonomous mixer 502 is configured to determine one or more transition parameters, including a mix point based on an alignment (e.g., in a time scale) of beat S1bX of song 550 to beat S2b1 of song 552. At time S1Bx (e.g., a mix point), scheduler system 540 initiates playback scheduled events of transitioned audio 554, which includes starting playback of song (“S2”) as a function of content offset and beat S2B1. Scheduler system 540 also can apply a playback rate of R2 to be set for S2. Further, scheduler system 540 applies to S1 with parameter R1. As shown in transition audio 554, the volume of S2 increases from an initial amount (i.e., V2i) to a final amount (i.e., V2f) over D2 seconds. At S1V1T1 seconds, the volume of S1 is decreased from an initial amount (i.e., V1) to a final amount (e.g., 0) over D1 seconds.

The above-described examples in FIGS. 4 and 5 may be implemented in a server-client architecture where a device, D, which is not shown, communicates with a server. Those of ordinary skill in the art, using the disclosures provided herein, understand that the methods and systems according to aspects of the present disclosure can be implemented other suitable architectures, such as one or more computing devices.

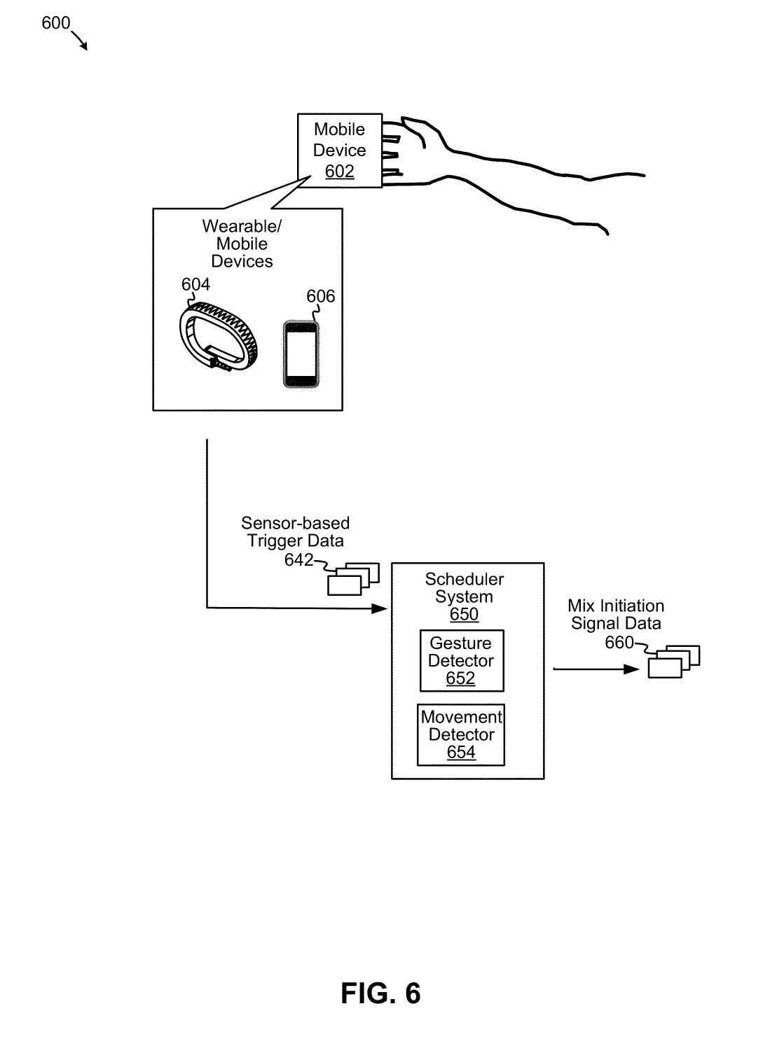

FIG. 6 depicts implementation of various sensor-based trigger data for initiating transition of audio tracks, according to some embodiments. Diagram 600 depicts a mobile device 602 they can be implemented as a wearable computing device 604 or a mobile computing device 606, either of which includes sensors as an interface for generating data 642 indicative of user-generated triggers.

Diagram 600 also depicts a scheduler system 650 including a gesture detector 652 and a movement detector 654. Gesture detector 652 is configured to receive data 642 (e.g., based on motion sensors, accelerometers, gyroscopes, capacitive sensors, etc.) and to detect that such data represents a gesture indicative of a user's request to initiate a transition. Similarly, movement detector 654 is configured to receive data 642 (e.g., based on motion sensors, accelerometers, gyroscopes, etc.) and to detect that such data represents movement (e.g., timing associated with steps or strides) as an implicit request to initiate a transition. A request to initiate a transition can be generated as data 660, with which one or more of the components described herein can be used to facilitate a transition from one audio track to another audio track based on any arbitrary trigger point in time.

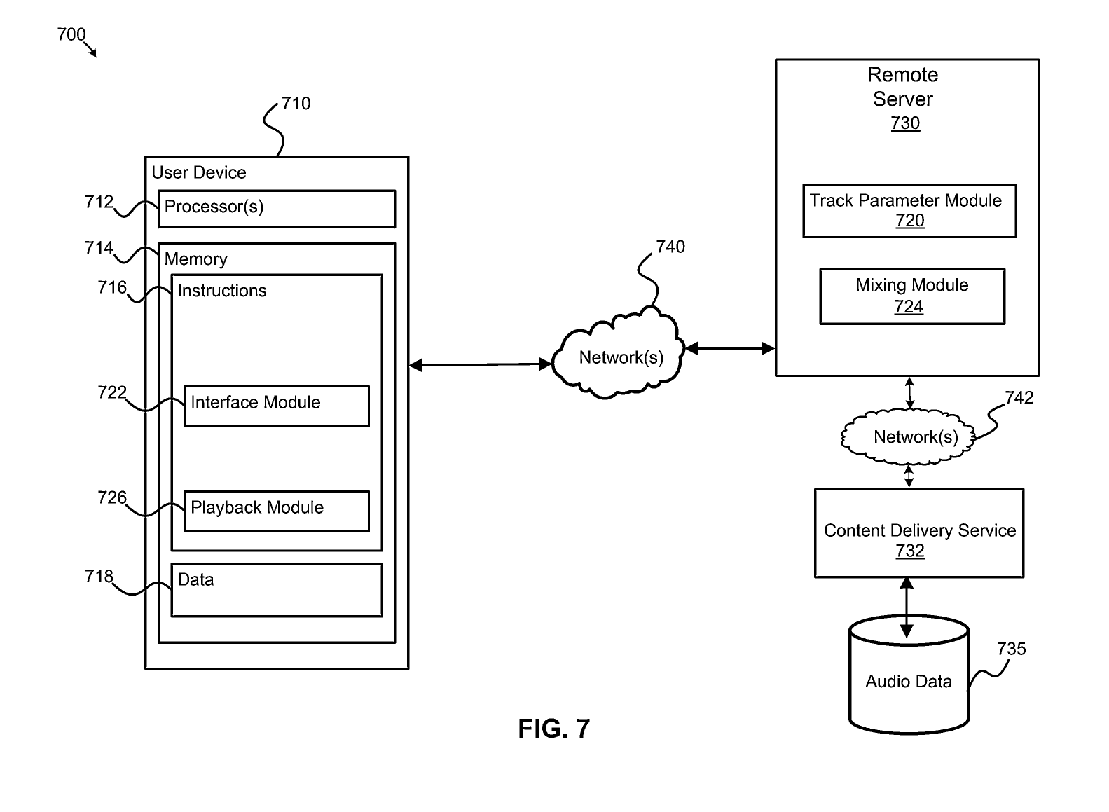

FIG. 7 depicts another example of a computing system, according to one or more embodiments. System 700 includes a computing device 710 and a remote server 730. As shown, computing device 710 can have a processor(s) 712 and a memory 714. Computing device 710 can also include a network interface used to communicate with remote computing devices over a network 740. In particular implementations, computing device 710 can be in communication with a remote server 730, such as a web server, via network 740. Remote server 730 can be coupled to, or in communication with, a content delivery service 732, such as Spotify™, Rdio™, iTunes™, etc., which includes audio data and metadata in repository 735. Database 735 can include media for serving via network 742 to remote devices and associated metadata. In particular implementation, a user device implemented as computing device 710 can access content (e.g., streamed audio content) from remote server 730 or from data 718. Instructions 716 can be any set of instructions that, when executed by the processor(s) 712, cause any of processor(s) 712 to provide desired functionality. For instance, instructions 716 can be executed by processor(s) 712 to implement an interface module 722 and a playback module 726.

Note that in the system shown, remote server 730 includes hardware, software, and/or logic configured to implement a track parameter module 720 and a mixing module 724. As such, remote server 730 can be configured to identify audio characteristics and/or transition parameters for use by user device 710. In various other implementations, one or more modules of device 710 can be disposed in remote server 730, and one or more modules of remote server 730 can be disposed in user device 710.

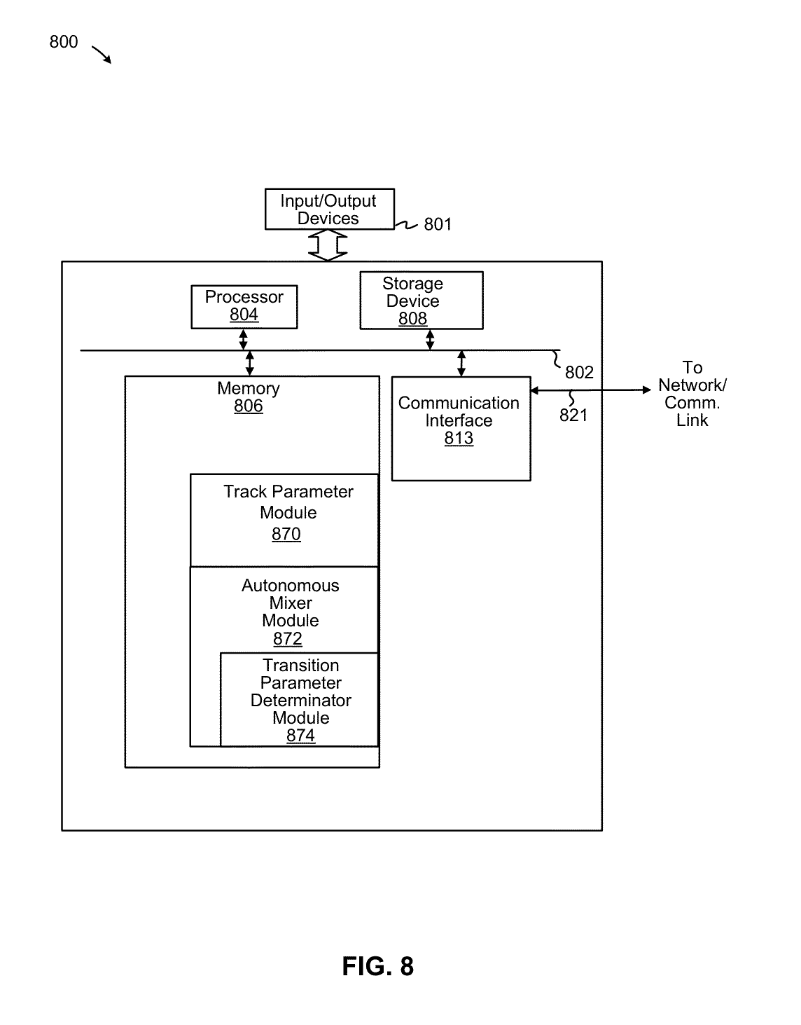

FIG. 8 illustrates an exemplary computing platform configured to provide autonomous audio transitions in accordance with various embodiments. In some examples, computing platform 800 may be used to implement computer programs, applications, methods, processes, algorithms, or other software to perform the above-described techniques.

In some cases, computing platform can be disposed in wearable device or implement, a mobile computing device, or any other device.

Computing platform 800 includes a bus 802 or other communication mechanism for communicating information, which interconnects subsystems and devices, such as processor 804, system memory 806 (e.g., RAM, etc.), storage device 8012 (e.g., ROM, etc.), a communication interface 813 (e.g., an Ethernet or wireless controller, a Bluetooth controller, etc.) to facilitate communications via a port on communication link 821 to communicate, for example, with a computing device, including mobile computing and/or communication devices with processors. Processor 804 can be implemented with one or more central processing units (“CPUs”), such as those manufactured by Intel® Corporation, or one or more virtual processors, as well as any combination of CPUs and virtual processors. Computing platform 800 exchanges data representing inputs and outputs via input-and-output devices 801, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 800 performs specific operations by processor 804 executing one or more sequences of one or more instructions stored in system memory 806, and computing platform 800 can be implemented in a client-server arrangement, peer-to-peer arrangement, or as any mobile computing device, including smart phones and the like. Such instructions or data may be read into system memory 806 from another computer readable medium, such as storage device 808. In some examples, hard-wired circuitry may be used in place of or in combination with software instructions for implementation. Instructions may be embedded in software or firmware. The term “computer readable medium” refers to any tangible medium that participates in providing instructions to processor 804 for execution. Such a medium may take many forms, including but not limited to, non-volatile media and volatile media. Non-volatile media includes, for example, optical or magnetic disks and the like. Volatile media includes dynamic memory, such as system memory 806.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 802 for transmitting a computer data signal.

In some examples, execution of the sequences of instructions may be performed by computing platform 800. According to some examples, computing platform 800 can be coupled by communication link 821 (e.g., a wired network, such as LAN, PSTN, or any wireless network) to any other processor to perform the sequence of instructions in coordination with (or asynchronous to) one another. Computing platform 800 may transmit and receive messages, data, and instructions, including program code (e.g., application code) through communication link 821 and communication interface 813. Received program code may be executed by processor 804 as it is received, and/or stored in memory 806 or other non-volatile storage for later execution.

In the example shown, system memory 806 can include various modules that include executable instructions to implement functionalities described herein. In the example shown, system memory 806 includes a track parameter module 870, and an autonomous mixer module 872, which includes a transition parameter determinator module 874, one or more of which can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, an autonomous mixer or one or more of its components (or any other structure/function described herein), or any process or device described herein, can be in communication (e.g., wired or wirelessly) with a mobile device, such as a mobile phone or computing device, or can be disposed therein. In some cases, a mobile device, or any networked computing device (not shown) in communication with an autonomous mixer or one or more of its components (or any other structure/function or any process or device described herein), can provide at least some of the structures and/or functions of any of the features described herein. As depicted in FIG. 1 and/or subsequent figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, an autonomous mixer or one or more of its components, any of its one or more components, or any process or structure/device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in FIG. 1 (or any subsequent figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, an autonomous mixer, including one or more other components, or any process or device described herein, can be implemented in one or more computing devices that include one or more circuits. Thus, at least one of the elements in FIG. 1 (or any subsequent figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive. While the present subject matter has been described in detail with respect to specific exemplary embodiments and methods thereof, it is appreciated that those skilled in the art, upon attaining an understanding of the foregoing may readily produce alterations to, variations of, and equivalents to such embodiments. Accordingly, the scope of the present disclosure is by way of example, rather than by way of limitation, and the subject disclosure does not preclude inclusion of such modifications, variations and/or additions to the present subject matter is readily apparent to one of ordinary skill in the art.

What is claimed:

1. A computer-implemented method, comprising:
identifying, with a computing device, a first audio characteristic of a first audio track;
identifying, with the computing device, a second audio characteristic of a second audio track;
receiving, at the computing device, data representing a user-generated trigger;
determining a transition parameter, responsive to the user-generated trigger, for the first audio track and the second audio track based on one or more of the first audio characteristic and the second audio characteristic; and
causing presentation of a transition from the first audio track to the second audio track.

2. The computer-implemented method of claim 1, wherein the first audio characteristic and the second audio characteristic comprise one or more of a tempo, beat phrase, key, and time signature.

3. The computer-implemented method of claim 1, wherein identifying the first audio characteristic and the second audio characteristic respectively comprise:
identifying a first beat-per-minute; and
identifying a second beat-per-minute.

4. The computer-implemented method of claim 1, further comprising:
identifying data representing a first track portion of the first audio track based on first audio characteristic;
identifying data representing a second track portion of the second audio track based on second audio characteristic; and
aligning the second track portion to the first track portion at a processor of the computing device to form a mix point autonomously.

5. The computer-implemented method of claim 4, further comprising:
applying the transition parameter to cause modification of a volume to cause fading of either the first audio track or the second audio track, or both.

6. The computer-implemented method of claim 1, wherein identifying the first audio characteristic and the second audio characteristic is responsive to receiving the data representing the user-generated trigger.

7. The computer-implemented method of claim 1, wherein determining the transition parameter comprises:
identifying metadata; and
determining the transition parameter based on the metadata associated with the first audio track or the second audio track.

8. The computer-implemented method of claim 1, wherein receiving the data representing the user-generated trigger comprises:
receiving data indicative of a user interaction with a user interface.

9. The computer-implemented method of claim 8, further comprising:
receiving data indicative of a gesture based on sensor data.

10. The computer-implemented method of claim 8, further comprising:
receiving data indicative of a movement based on sensor data.

11. The computer-implemented method of claim 8, further comprising:
receiving data indicative of a change in environment including a change in ambient noise.

12. The computer-implemented method of claim 1, wherein the transition parameter comprises data representing one or more of a mix point, a reverb processing parameter, a fade-out time for the first audio track, a fade-in time for the second audio track, and a playback rate of the second audio track.

13. The computer-implemented method of claim 1, further comprising:
transitioning from the first audio track to the second audio track based at least in part on the transition parameter.

14. A system comprising:
a memory comprising:
executable instructions to implement a track parameter module configured to identify a first audio characteristic of a first audio track, and to identify a second audio characteristic of a second audio track; and
executable instructions to implement an autonomous mixer module configured to determine a transition parameter for the first audio track and the second audio track based on one or more of the first audio characteristic and the second audio characteristic; and
a processor configured to execute the executable instructions to implement the track parameter module and the autonomous mixer module, the processor further configured to receive data representing a user-generated trigger and to cause presentation of a transition from the first audio track to the second audio track.

15. The system of claim 14, wherein the first audio characteristic and the second audio characteristic comprise a tempo.

16. The system of claim 15, wherein the first audio characteristic and the second audio characteristic respectively comprise:
a first beat-per-minute; and
a second beat-per-minute.

17. The system of claim 16, wherein the processor is configured to execute another set of executable instructions to implement the autonomous mixer module, which is configured to determine a first subset of beats determined by the first beat-per-minute and to determine a second subset of beats determined by the second beat-per-minute,
wherein the processors is configured to align the first subset of beats to the second subset of beats to form a midpoint autonomously.

18. The system of claim 14, wherein the executable instructions to implement the track parameter module comprise:
executable instructions to identify metadata and to determine the transition parameter based on the metadata associated with the first audio track or the second audio track.

19. The system of claim 14, wherein the processor is further configured to receive data indicative of a gesture based on sensor data as the user-generated trigger.

20. The system of claim 14, wherein the processor is further configured to receive data indicative of a movement based on sensor data as the user-generated trigger.
